(19) United States
(12) Patent Application Publication
(10) Pub. No.: US 2006/0188692 A1
(43) Pub. Date: Aug. 24, 2006

(54) Fire-resistant ceramic gas sink

(75) Inventor: Andreas Drescher, Wien (AT)

Correspondence Address: WALKER & JOCKE, L.P.A., 231 SOUTH BROADWAY STREET, MEDINA, OH, 44256, US

(73) Assignee: Refractory Intellectual Property GmbH 7 Co. KG, Wein (AT)

(21) Appl. No.: 10/544,688

(22) PCT Filed: Dec. 24, 2003
(86) PCT No.: PCT/EP03/14904

§ 371 Date: Apr. 5, 2006

(30) Foreign Application Priority Data
Feb. 8, 2003 (DE) 103 05 232.1

(51) Int. Cl. B32B 3/10

(52) U.S. Cl. 428/131; 428/702

(57) ABSTRACT

The invention relates to a fire-resistant ceramic gas sink which can be fitted into a wall or the base of a vessel for receiving a metal melt. The gas sink comprises at least one channel extending from the cold side of the gas sink to a hot side thereof. The channel is fluidically connected on the cold side thereof to a gas supply device enabling a treatment gas to be introduced via said canal into the metal melt.

The present invention relates to a refractory ceramic gas flushing brick (=gas purging brick) for installation in a wall or a bottom of a vessel for receiving a molten metal, the gas flushing brick having at least one channel running from the cold side of the gas flushing brick to a hot side of the gas flushing brick and the channel being fluidically connected at the cold side of the gas flushing brick to a gas supply device, via which a treatment gas may be conducted through the channel into the molten metal.

Such a gas flushing brick is referred to as a gas flushing brick “having oriented (directed) porosity” because of the arrangement of a gas flushing channel. The further nomenclature may be inferred from the comprehensive representation in “Radex-Rundschau” 1987, 288.

In addition to gas flushing bricks having “oriented porosity”, which may include “slit purging element” as a subgroup, in particular, gas flushing elements having “non-oriented porosity” are known, in which the gas moves from the cold side to the hot side of the gas flushing brick through an “open pore framework” within the refractory matrix material.

When reference is made to “cold side” and/or “hot side”, this obviously relates to the installed state of the gas flushing brick in a vessel for receiving (including treating) a molten metal. The hot side is thus the side which directly neighbors the molten metal, the molten metal typically pressing against the hot side. The cold side is correspondingly the side of the gas flushing brick which neighbors the outer vessel envelope.

A gas flushing element of the type according to the species is disclosed in DE 38 10 098 C1. Typically, such a gas flushing brick has multiple flushing channels, which essentially extend in the axial direction of the gas flushing brick (i.e., in the flow direction of the gas). If one assumes an overall length of the gas flushing brick between 30 and 120 cm, it becomes clear that the implementation of the flushing channels within the ceramic base material is extraordinarily difficult, because the channels typically have diameters <5 mm, sometimes <2 mm. However, this is not discussed in the related art, because the related art is only concerned with conveying the gas from the cold side to the hot side and subsequently into the molten metal. The gas flushing channels thus correspondingly fulfill their function even if they run curved, diagonally, or discontinuously in any way between the cold side and the hot side.

A gas flushing element having oriented porosity, in which the flushing channels are implemented between neighboring ceramic bodies, is known from EP 1 101 825 A1.

The goal of gas flushing in, for example, a steel casting ladle is particularly more rapid temperature and concentration equalization of the steel bath and its purification. In particular, non-metallic inclusions are to be conveyed more rapidly into the slag floating on the molten bath with the aid of the gas flow.

Conducting powdered treatment materials with the gas flow into the molten metal is also known. DE 38 10 098 C 1, cited above, additionally offers the possibility of conducting an alloying wire along a tubular passage channel in the gas flushing brick into the melt. In this case, the alloy wire is supplied from the outside and runs through a gas distributor chamber, which is implemented on the cold-side end of the gas flushing brick and supplies the further flushing channels with flushing gas.

Known gas flushing devices are thus parts for secondary-metallurgical treatment of molten metals.

The present invention is based on the object of redesigning a gas flushing brick of the cited type in such a way that it may assume further tasks.

These further tasks include, in particular, the observation (checking) of the operational status of the molten metal to be treated, for example, temperature and composition of the melt.

For this purpose, the present invention suggests a gas flushing brick of the type cited at the beginning, which has the following additional features:
at least one measuring device for determining physical and/or chemical data of the molten metal, which neighbors the hot side of the gas flushing brick after the gas flushing brick is installed in the vessel,
a measuring head of the measuring device projecting into a channel of the gas flushing brick.

At least one of the gas flushing channels of the gas flushing brick is used to receive a measuring device. The measuring device is to be guided into the channel at the cold side of the flushing brick. The measuring device is to be positioned and be attached in such a way that it is removable. In this way, the measuring device may be removed when changing the purging element (after its wear) and reused for a further purging element. The attachment may be performed on the outer mantle of the metallurgical vessel or on the cold-side end of the gas flushing brick. A gas distributor chamber, which may be attached to the cold side of the gas flushing brick, also offers an attachment possibility. The gas distribution chamber may be removably attached to the cold end of the gas flushing brick. Parts of the gas distributor chamber may also be removably fixed here. The gas distributor chamber is used for the purpose of distributing the gas from the gas supply device to multiple flushing channels. In a gas flushing brick according to the present invention, the channel into which the measuring head of the measuring device is stuck may also be flushed. According to one embodiment, a passage opening remains free for the treatment gas between the measuring head and channel for this purpose. The passage opening may be an annular channel between measuring head and flushing channel. The flusher may also be designed, however, so that the flushing gas is first introduced “behind” the measuring head into the channel section running in an extension of the channel to receive the measuring head (like a bypass). The following advantages may be achieved by the different variations:
The measuring head may be cooled.
Different functional channels may have gas applied to them from one single gas distributor chamber.
The gas flow and/or gas application prevents penetration (infiltration) of molten metal into the channel in which the measuring head lies.
If the channel is implemented as linear, the measuring head may receive signals from the molten metal directly.

It is important that the channel into which the measuring head is stuck is suitable for conducting electromagnetic signals from the melt to the measuring head.

The gas distributor chamber may be subdivided into partial chambers. Individual groups of channels may then be connected or disconnected. Different flushing gases may also be supplied.

Typically, it suffices to have the measuring head of the measuring device project into the channel at most up to the end of the first third of the total length of the channel. In other words: starting from the hot side of the gas flushing brick, the channel initially does not differ from a typical flushing channel; it is free of installed parts. The measuring head, which the flushing gas may flow around, only lies in the “rear” third (on the cold side). This part of the channel may have larger cross-section than the section lying in front of it, viewed from the hot side. The transition may be stepped or continuous.

In order that the measuring head may receive measuring signals as optimally as possible, the “measuring channel” is to run linearly. “Linearly” is defined in this case according to the present invention so that the measuring head may detect at least 50% of the cross-sectional area of the channel on the hot side of the gas flushing brick. Ideally, the value will be 100%.

The channel may run at a right angle to the hot-side front face of the gas flushing brick, i.e., parallel to the central longitudinal axis of the gas flushing brick, if the gas flushing brick is designed as cylindrical or as a truncated cone, for example.

The channel may also run at an angle unequal to 90° to the front face if the gas is to be guided in a targeted way, for example into the center of the molten metal.

The channel may be implemented having different internal cross-sections. The cross-section may expand continuously from the cold side to the hot side of the gas flushing brick—or vice versa; it may, of course, also be constant.

The cross-sectional area of the channel on the hot side is, above all, typically between 0.5 and 20 mm². The cross-sectional shape of the channel is basically arbitrary. For example, it may be circular, triangular, rectangular, or have the shape of a polygon, oval, or a star shape.

Corresponding cross-sectional shapes also apply for the measuring device, measuring device and channel preferably having different cross-sectional shapes in order to ensure that the flushing gas flows around the measuring head as required.

Accordingly, one embodiment suggests that at least the part of the measuring device projecting into the channel have a cross-sectional shape which differs from the cross-sectional shape of the corresponding channel section.

The channels may be drilled. Alternatively, the individual channels may be formed by pre-manufactured tubes which are integrated into the gas flushing brick. These tubes may be made of ceramic or metal, for example, and have a surface on the inside which reflects electromagnetic radiation. The channels may also be produced by burning out molded elements when manufacturing the flushing device.

This channel implementation is advantageous above all if the measuring device is implemented for receiving and relaying electromagnetic waves which are emitted by the molten metal into the channel. The measuring device then comprises parts for receiving and relaying electromagnetic waves, particularly in the visible light range and/or in the infrared spectral range and/or in the UV range. Such electromagnetic waves are emitted by the molten metal and may be converted in an associated analysis unit into temperature values and/or values for determining the chemical analysis. Such devices are known, for example, from WO-A-97/22859 and WO-A-02/48661.

The gas flushing brick may also be equipped with a device which displays the residual thickness of the brick. This display is activated when the gas flushing brick is worn that the functional reliability of the measuring device would be impaired if it is used further. Such a device may be provided, for example, by a gas channel which runs outward from the gas distributor chamber, but ends at a specific distance to the hot side of the flushing brick. Only when the gas flushing brick has been worn up to this region the channel will be quasi-“opened” and gas will flow through the channel into the molten metal. The gas pressure within the associated gas distributor chamber will drop simultaneously, which may be displayed accordingly.

As already noted, the measuring device may be positioned especially advantageously in the region of the gas distributor chamber. It may be inserted through an opening in the outer wall of the gas distributor chamber and extend through the gas distributor chamber into the described channel. A gland seal may guide the measuring device and seal it in relation to the gas distributor chamber. The gas distributor chamber may be removably attached to a flange, which is attached to the cold side of the flusher, for replaceability and reuse.

Further features of the present invention result from the features of the subclaims and the other documents of the application. This includes the possibility of assigning multiple channels to the measuring device. The cross-sections of the channels may thus be kept small on the hot side, but the desired quantity of (electromagnetic) radiation may still be conducted to the measuring cell.

Alternatively, the measuring device covers multiple channels.

The present invention will be explained in greater detail in the following on the basis of two exemplary embodiments. The figures each show, in a schematic illustration, a section through an embodiment of a gas flushing brick according to the present invention.

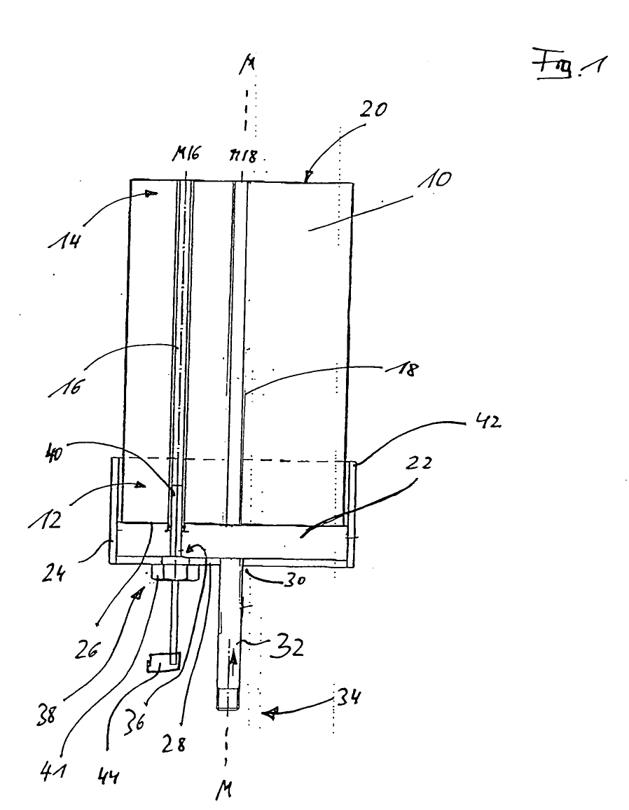

This conventionally comprises, as shown in FIG. 1, a refractory ceramic body 10 having a “cold side” 12 and a “hot side” 14. Flushing channels 16, 18 extend from the cold side 12 to the hot side 14. The central longitudinal axes M16, M18 of the flushing channels 16, 18 run exactly parallel to the central longitudinal axis M of the gas flushing brick and at a right angle to the front face 20 of the hot side 14 of the body 10.

A gas distributor chamber 22 adjoins the cold side 12 of the body 10, which is constructed as follows:

The gas distributor chamber 22 is delimited on top by a lower front face 26 of the ceramic body 10. A metal envelope 24 runs around the circumference, which is shrunk onto the cold-side end 12 of the body 10 and projects downward past the front face 26. A bottom plate 28 terminates the envelope 24 parallel and at a distance to the front face 26. Two openings are provided in the bottom plate 28. The first opening 30 is used to connect a gas supply pipe 32, which is a component of a gas supply device 34 that comprises, among other things, a gas reservoir (not shown).

A measuring device 38 extends through a further opening 36. The measuring device 38 is externally attached gas-tight in relation to the bottom plate 28 via a gland seal 41 and additionally has a measuring head 40 extending through the gas distributor chamber 22 into the channel 16. The measuring head 40 ends at a distance in front of an upper edge 42 of the metal envelope 24, i.e., at a large distance in front of the front face 20 at the hot end 14 of the flushing brick body 10.

The flushing channel 16 has an internal diameter which is 1.5 mm larger than the external diameter of the measuring head 40, so that a 0.75 mm wide annular gap runs on all sides around the measuring head 40. Correspondingly, gas may flow out of the gas distributor chamber 22 around the measuring head 40 and further through the channel 16 to the hot side 20. Of course, this applies analogously for the channel 18 and further flushing channels (not shown).

The measuring head 40 is implemented so that it receives electromagnetic waves emitted by a molten metal in the channel 16 and relays them to an analysis unit 44, which calculates the temperature of the molten metal on the basis of the intensity of the received electromagnetic waves.

Further measuring devices may be positioned analogously in further flushing channels in order to determine the chemical composition of the molten metal, for example.

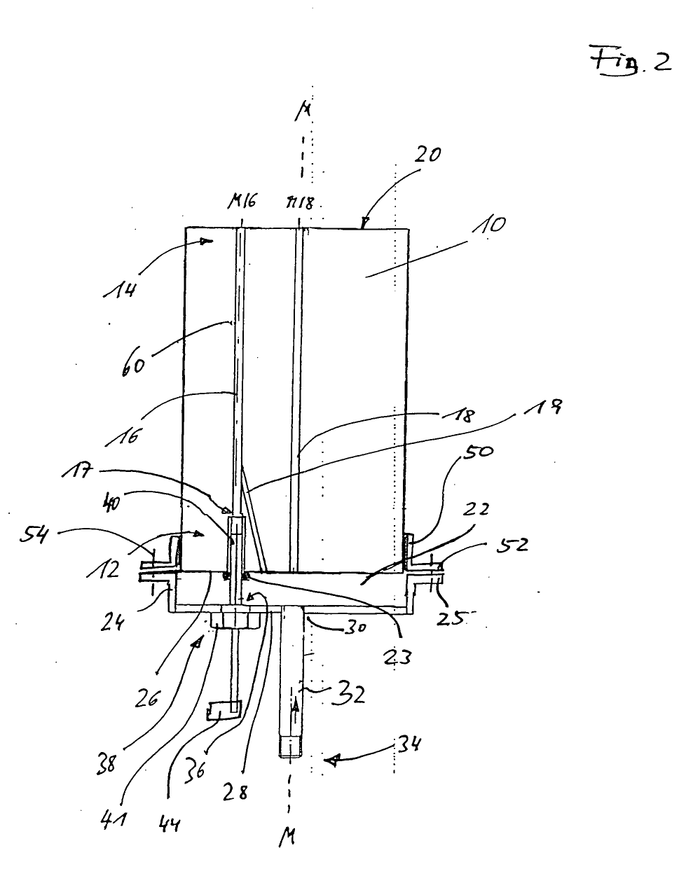

A second embodiment of a gas flushing device according to the present invention is illustrated in FIG. 2. Only the essential differences to the embodiment shown in FIG. 1 will be described further in the following.

A metal flange 50, which has a radially projecting leg 52, is attached externally to the cold side of the ceramic body 10. The peripheral metal envelope 24 of the gas distributor chamber 22 is correspondingly angled radially outward on its upper end (leg 25). The gas distributor chamber 22 may thus be removably attached to the flange 52 via screws 54.

If the gas flushing brick and/or its ceramic body 10 is worn, the gas distributor chamber 22 may be removed and attached analogously to a new ceramic body 10. In this way, above all, the measuring device 38 may be reused without problems.

A further difference is the design of the flushing channels 16, 18. The flushing channel 18 has a smaller cross-sectional area than in the exemplary embodiment shown in FIG. 1. For the flushing channel 16, this only applies in regard to the section above the measuring head 40, so that the channel 16 is implemented having a step 17 in the transition region. The upper section of the channel 16 is formed by a ceramic tube 60 which is embedded in the body 10. The measuring head 40 is sealed in relation to the interior of the gas distributor chamber 22 by a ring seal 23. Flushing gas is first conducted into the channel 16 behind the measuring head 40 (in FIG. 2: above the measuring head 40) via a further flushing channel 19, which has the function of a bypass.

1. A refractory ceramic gas flushing brick for installation in a wall or a bottom of a vessel for receiving a molten metal, having the following features:
a) at least one channel (16, 18) running from a cold side (12) to a hot side (14) of the gas flushing brick,
b) the channel (16, 18) is fluidically connected to a gas supply device (34) on the cold side (12) of the gas flushing brick, via which a treatment gas may be conducted through the channel (16, 18) into the molten metal,
c) at least one measuring device (38) for determining physical and/or chemical data of the molten metal, which neighbors the hot side (14) of the gas flushing brick after the gas flushing brick is installed in the vessel,
d) a measuring head (40) of the measuring device (38) projects into the channel (16).

2. The gas flushing brick according to claim 1, wherein a passage opening for the treatment gas remains free between measuring head (40) and channel (16).

3. The gas flushing brick according to claim 1, wherein the gas supply device (34) comprises at least one gas distributor chamber (22).

4. The gas flushing brick according to claim 3, wherein the gas distributor chamber (22) or a part of the gas distributor chamber (22) is removably attachable to the cold-side end of the gas flushing brick.

5. The gas flushing brick according to claim 3, wherein the gas distributor chamber (22) is removably attached to a flange (52) positioned on the cold side (12) of the gas flushing brick.

6. The gas flushing brick according to claim 3 having multiple channels (16, 18), wherein all channels (16, 18) or groups of channels are connected to the gas distributor chamber (22).

7. The gas flushing brick according to claim 1, wherein the measuring head (40) of the measuring device (38) projects into the channel (16) at most up to the end of the first third of the total length of the channel (16).

8. The gas flushing brick according to claim 1, wherein the channel (16, 18) runs linearly.

9. The gas flushing brick according to claim 1, wherein the channel (16, 18) is implemented so that the measuring head (40) detects at least 50% of the cross-sectional area of the channel (16) at the hot side (14) of the gas flushing brick.

10. The gas flushing brick according to claim 1, wherein the channel (16, 18) runs at a right angle to the front face (20) of the gas flushing brick at the hot side (14).

11. The gas flushing brick according to claim 1, wherein the internal cross-section of the channel (16) is smaller at the cold side (14) than at the hot side (12) of the gas flushing brick.

12. The gas flushing brick according to claim 1, wherein the channel (16, 18) has a cross-sectional area between 0.5 and 20 mm².

13. The gas flushing brick according to claim 1, wherein the channel (16, 18) has one of the following cross-sectional shapes: circle, triangle, rectangle, polygon, oval, star shape.

14. The gas flushing brick according to claim 1, wherein the channel (16, 18) is formed by a drilled hole implemented in the gas flushing brick.

15. The gas flushing brick according to claim 1, wherein the channel (16, 18) is formed by a tube (60) integrated into the gas flushing brick.

16. The gas flushing brick according to claim 15, wherein the tube (60) has an inner surface which reflects electromagnetic radiation.

17. The gas flushing brick according to claim 15, wherein the tube (60) comprises metal or ceramic.

18. The gas flushing brick according to claim 1, wherein at least the part (40) of the measuring device (38) projecting into the channel (16) has one of the following cross-sectional shapes: circle, triangle, rectangle, polygon, oval, star shape.

19. The gas flushing brick according to claim 1, wherein at least the part of the measuring device (38) projecting into the channel (16) has a cross-sectional shape which is different from the cross-sectional shape of the corresponding channel section (16).

20. The gas flushing brick according to claim 3, wherein the measuring device (38) is attached to the gas distributor chamber (22).

21. The gas flushing brick according to claim 3, wherein the measuring device (38) extends partially through an interior of the gas distributor chamber (22).

22. The gas flushing brick according to claim 1, wherein the measuring device (38) is a temperature measuring device.

23. The gas flushing brick according to claim 1, wherein the measuring device (38) is a measuring device for determining a chemical analysis of the molten metal.

24. The gas flushing brick according to claim 1, wherein the measuring device (38) is implemented for receiving and relaying electromagnetic waves which are emitted by the molten metal in the channel.

25. The gas flushing brick according to claim 1 having a residual thickness detector.

26. The gas flushing brick according to claim 1, wherein the residual thickness detector is implemented so that it is activated before the gas flushing brick is worn up that the functional reliability of the measuring device is impaired.

27. The gas flushing brick according to claim 1, wherein the measuring device (38) is removably attached to the cold side (12) of the gas flushing brick.
